(19) United States
(12) Patent Application Publication
(10) Pub. No.: US 2018/0227083 A1
(43) Pub. Date: Aug. 9, 2018

(54) METHOD FOR UPDATING FIRMWARE OF LOW POWER WIDE AREA MODULE

(71) Applicant: SAMSUNG ELECTRO-MECHANICS CO., LTD., Suwon-si (KR)

(72) Inventors: Byong Hyok CHOI, Suwon-si (KR); In Joo Na, Suwon-si (KR); Sun Hwa Kim, Suwon-si (KR); Jae Soon Lee, Suwon-si (KR); Chul Wan Park, Suwon-si (KR)

(73) Assignee: SAMSUNG ELECTRO-MECHANICS CO., LTD., Suwon-si (KR)

(21) Appl. No.: 15/848,689

(22) Filed: Dec. 20, 2017

(30) Foreign Application Priority Data
Feb. 3, 2017 (KR) 10-2017-0015489

(51) Int. Cl. H04L 1/18; G06F 8/65; G06F 21/64; H04W 28/04

(52) U.S. Cl. CPC H04L 1/18; H04W 28/04; G06F 21/64; G06F 8/65

(57) ABSTRACT

A method to update firmware of a low power wide area (LPWA) module includes: transmitting, from a gateway, an over the air (OTA) request message including an OTA transmission time to the LPWA module; transmitting, from the gateway, OTA packets including a firmware source to the LPWA module at the OTA transmission time; and receiving, at the gateway, an OTA response message from the LPWA module confirming whether a reception of the plurality of OTA packets is completed.

### CROSS-REFERENCE TO RELATED APPLICATIONS

This application claims the benefit under 35 USC 119(a) of Korean Patent Application No. 10-2017-0015489 filed on Feb. 3, 2017 in the Korean Intellectual Property Office, the entire disclosure of which is incorporated herein by reference for all purposes.

### BACKGROUND

### 1. Field

The following description relates to a method for updating firmware of a low power wide area (LPWA) module.

### 2. Description of Related Art

Demand for Internet of Things (IoT) services for monitoring and control of an equipment, asset tracking, and environmental sensing, for example, in various fields, has increased. In order to provide such IoT services, a low power wide area (LPWA) module technology, which is differentiated from a conventional local area wireless communications technology or mobile communications technology, has come to prominence.

The low power wide area (LPWA) module technology has an advantage with respect to local area wireless communications in that LPWA module technology is capable of performing long distance communications, and has an advantage with respect to long term evolution (LTE) communications in that LPWA module technology has lower costs and less power consumption.

In a LPWA system, a server may update system information with the LPWA module connected with application devices (e.g., a metering device, a tracking device, and a sensor device) through a gateway. This type of updating is typically known as over-the-air (OTA) updating.

However, in order to update firmware of the LPWA module, an OTA protocol suitable for mass data is required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method to update firmware of a low power wide area (LPWA) module includes: transmitting, from a gateway, an over the air (OTA) request message including an OTA transmission time to the LPWA module; transmitting, from the gateway, OTA packets including a firmware source to the LPWA module at the OTA transmission time; and receiving, at the gateway, an OTA response message from the LPWA module confirming whether a reception of the plurality of OTA packets is completed.

The transmitting of the OTA request message may be performed after the gateway receives an uplink of the LPWA module.

The transmitting of the OTA packets may include transmitting an OTA packet, among the OTA packets, to the LPWA module, and transmitting a next OTA packet, among the OTA packets, to the LPWA module in response to receiving a positive acknowledgement (ACK) from the LPWA module.

The OTA response message may include a sequence number of a failed OTA packet, among the OTA packets, that fails to be received by the LPWA module.

The method may further include retransmitting the failed OTA packet in response to the gateway receiving the OTA response message including the sequence number of the failed OTA packet.

The method may further include transmitting an update instruction message to the LPWA module in response to the OTA response message indicating a reception completion of the firmware source.

The OTA request message may include an indicator indicating a unicast or multicast communications method.

In another general aspect, a non-transitory computer-readable storage medium stores instructions that, when executed by a processor, cause the processor to perform the method described above.

In another general aspect, a method to update firmware of low power wide area (LPWA) modules includes: transmitting, from a gateway, an over the air (OTA) request message including an OTA transmission time to the LPWA modules; transmitting, from the gateway, OTA packets including a firmware source to the LPWA modules as a subgroup at the OTA transmission time; and receiving, at the gateway, an OTA response message from each of the LPWA modules confirming whether a reception of the subgroup is completed.

The transmitting of the OTA request message may be performed after the gateway receives an uplink of a respective LPWA module, among the LPWA modules.

The OTA request message may further include a sequence number of the subgroup, and a quantity of the OTA packets included in the subgroup.

The sequence number of the subgroup may include a sequence number of a first OTA packet, among the OTA packets, included in the subgroup.

The OTA response message may include a sequence number of a failed OTA packet, among the OTA packets, that fails to be received by a respective LPWA module, among the LPWA modules.

The method may further include retransmitting the failed OTA packet in response to the gateway receiving the OTA response message including the sequence number of the failed OTA packet.

The method may further include transmitting an update instruction message to a respective LPWA module, among the LPWA modules, in response to the OTA response message indicating a reception completion of the firmware source.

The OTA request message may include an indicator indicating a unicast or multicast communications method.

In another general aspect, a non-transitory computer-readable storage medium stores instructions that, when executed by a processor, cause the processor to perform the method described above.

Other features and aspects will be apparent from the following detailed description, the drawings, and the claims.

### BRIEF DESCRIPTION OF DRAWINGS

FIG. 1 is a diagram illustrating a communications system including a low power wide area (LPWA) module, according to an embodiment.

FIG. 2 is a flowchart of communications between a gateway and an LPWA module, according to an embodiment.

FIG. 3 is a flowchart of communications between a gateway and an LPWA module, according to another embodiment.

FIG. 4 is a diagram illustrating a frame structure of an OTA request message, according to an embodiment.

FIG. 5 is a diagram illustrating a frame structure of an OTA response message, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

Hereinafter, embodiments will be described in detail with reference to the accompanying drawings.

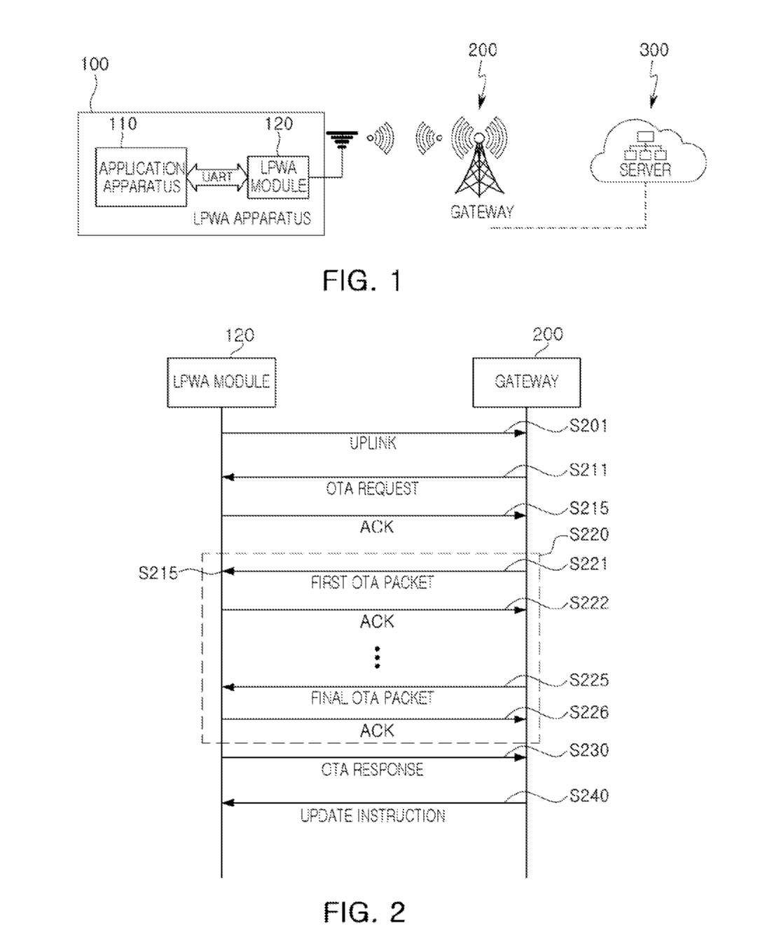

FIG. 1 is a diagram illustrating a communications system capable of implementing communications services, according to an embodiment.

Referring to FIG. 1, a network includes a LPWA apparatus 100, a gateway 200, and a server 300. Further, the network includes one or more LPWA apparatuses 100.

The LPWA apparatus 100 includes an application apparatus 110 and an LPWA module 120.

It should be noted that the LPWA apparatus 100 can be implemented in hardware and/or by hardware executing software. Accordingly, in various implementations, the application device 110 and the LPWA module 120 can be implemented by one or more processor circuits executing the appropriate software.

The application apparatus 110 may be a metering apparatus, a tracking apparatus including GPS, and a sensor apparatus, and may include processor circuits such as microcontrollers, microprocessors, and application specific integrated circuits (ASICs). Alternatively, the application apparatus 110 may be controlled by the processor circuit included in the LPWA module 120. Further, the application apparatus 110 may be connected to the LPWA module 120 in a wired manner. In an example, the application apparatus 110 and the LPWA module 120 communicate with each other in a universal asynchronous receiver/transmitter (UART) manner.

The LPWA module 120 provides data output from the application apparatus 110 to the server 300 through the gateway 200. Further, the server 300 transmits the data to the LPWA apparatus 100 through the gateway 200. That is, in a communications system, the data can be transmitted in two directions: uplink direction from the LPWA apparatus 100 to the server 300; and a downlink direction from the server 300 to the LPWA apparatus 100.

The communications system associated with such an LPWA module may be implemented by a standard communications type such as SIGFOX or LoRa (Long Range), using a non-licensed frequency band. SIGFOX may be based on an ultra narrow band (UNB) and LoRa may be based on IEEE 802.15.4g.

A communications method implementing the LPWA communications system is generally focused on the uplink and supports an over-the-air (OTA) operation for transmitting system registration information to the LPWA module 120, but does not support the downlink of mass data.

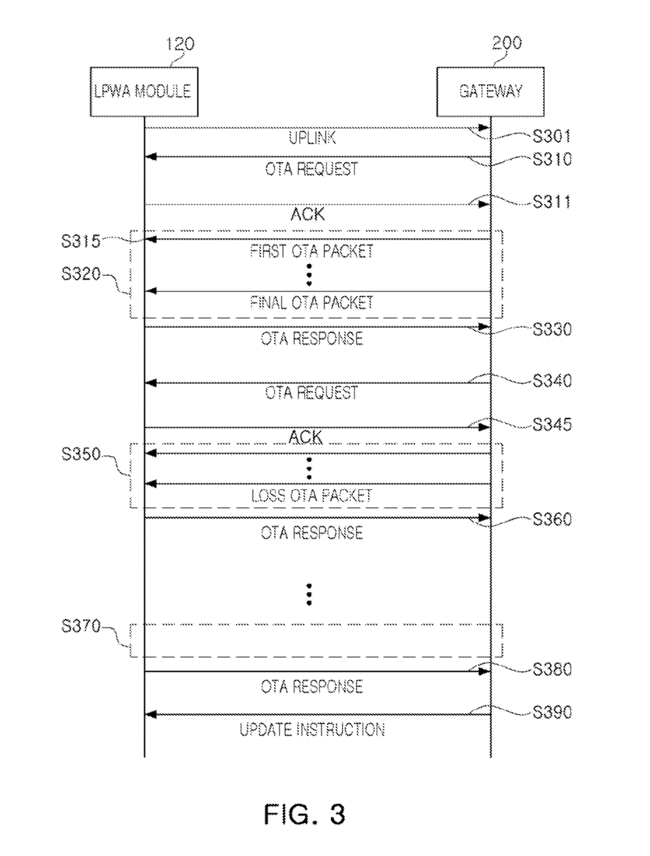

Hereinafter, a method for updating firmware of a low power wide area (LPWA) module of OTA unicast and OTA multicast communications methods based on a media access control (MAC) protocol will be described with reference to FIGS. 2 and 3.

FIG. 2 is a flowchart of communications between the gateway 200 and the LPWA module 120 in a method for updating firmware of the LPWA module 120, according to an embodiment.

In an initial operation S211 of the method for updating the firmware of the LPWA module 120, the gateway 200 transmits an over the air (OTA) request message to the LPWA module 120. However, in a case in which the LPWA module 120 is set to wait for a downlink of the gateway 200 after performing an uplink, the transmission of the OTA request message is performed after the gateway 200 receives the uplink of the LPWA module 120 in operation S201.

Thereafter, the LPWA module 120 transmits a positive acknowledgement (ACK) to the gateway in operation S211.

Next, in operation S215, the LPWA module 120 opens a reception window at a specific time to receive an OTA packet. The specific time may be designated by an OTA transmission time included in the OTA transmission message. In operation S220, the gateway 200 transmits OTA packets, including a firmware source, to the LPWA module at the OTA transmission time.

The operation S220 of transmitting the OTA packets may proceed in such a manner that the gateway 200 transmits one OTA packet to the LPWA module 120, receives the positive acknowledgement (ACK) from the LPWA module 120, and then transmits the OTA packet.

For example, the gateway 200 transmits a first OTA packet to the LPWA 120 module in operation S221, receives the positive acknowledgement (ACK) from the LPWA module 120 in operation S222, transmits a final OTA packet in operation S225 by repeating the transmission and reception, and receives positive acknowledgement (ACK) for the transmission of the final OTA packet from the LPWA module in operation S226.

After receiving the OTA packets, the LPWA module transmits an OTA response message to the gateway in operation S230 to indicate whether the reception of the OTA packets is completed.

The OTA response message may indicate a reception completion of the firmware source, but may also indicate a failure of the reception completion. In a case in which the OTA response message indicates the failure of the reception completion, the OTA response message may include a sequence number of failed (lost) OTA packets that the LPWA module 120 has failed to receive. In response to receiving the OTA response message including the sequence number of the failed OTA packets, the gateway 200 retransmits the failed OTA packets corresponding to the sequence number, and to this end, the gateway 200 may again transmit the OTA request message to the LPWA module 120.

Further, in a case in which the OTA response message received by the gateway from the LPWA module 120 indicates the reception completion of the firmware source, the gateway 200 transmits an update instruction message to the LPWA module 120 in operation S240. The update instruction may be included in the OTA request message so as to be transmitted as the OTA request message.

The above-described method for updating the firmware of the LPWA module 120 may be applied to a case in which an OTA unicast communications method is supported between the gateway 200 and the LPWA module 120. In an example, the LPWA module 120 performs a limited uplink. That is, the LPWA module 120 may operate in an activated state only when transmitting the data of the application apparatus 110 to the server 300 and be switched to an inactivated state when not transmitting the data of the application apparatus 110, or may be synchronized by receiving a beacon of the gateway 200 and operate in the activated state. The LPWA module 120 operating in such a manner may be supported by an OTA unicast communications method.

FIG. 3 is a flowchart of communications between the gateway 200 and the LPWA module 120 in a method for updating firmware of the LPWA module 120, according to another embodiment.

As described above in FIG. 2, in an initial operation S310 of the method for updating the firmware of the LPWA module 120 illustrated in FIG. 3, the gateway 200 transmits an over the air (OTA) request message to the LPWA module 120 (S310). Further, the transmission of the OTA request message may be performed after the gateway 200 receives the uplink of the LPWA module 120 in operation S301. However, the method for updating the firmware illustrated in FIG. 3 may include a case in which the gateway simultaneously communicates with multiple LPWA modules 120 to update the firmware source of the LPWA modules. Therefore, the LPWA module 120 illustrated in FIG. 3 may be referred to as LPWA modules 120.

Thereafter, the LPWA modules 120 may each transmit a positive acknowledgement (ACK) to the gateway 200 in operation S311.

At an OTA transmission time included in the OTA request message, the LPWA modules 120 each open a reception window in operation S315 and the gateway 200 transmits OTA packets including the firmware source in a unit of a subgroup to each of the LPWA modules 120 at the OTA transmission time. Specifically, the OTA packets may be transmitted by being divided into subgroups that each include some of the OTA packets. For example, in a case in which a total number (quantity) of the OTA packets including the firmware source is 1000, the OTA packets may be divided into five subgroups each including 200 OTA packets and transmitted in a unit of a subgroup.

In addition, the OTA request message may include a sequence number of the subgroups and the number (quantity) of the OTA packets included in the subgroups. Specifically, the sequence number of the subgroups may be a sequence number of a first OTA packet included in the subgroups.

As illustrated in FIG. 3, the gateway 200 sequentially transmits a first OTA packet to a final OTA packet of a first subgroup in operation S320.

After the first subgroup is transmitted, the LPWA modules 120 each transmit an OTA response message to the gateway to indicate whether the reception of the first subgroup is completed, in operation S330.

The OTA response message may indicate a reception completion for the packet of the first subgroup, but may also indicate a failure of the reception completion. In a case in which the OTA response message indicates the failure of the reception completion, the OTA response message may include a sequence number of failed (lost) OTA packets that the respective LPWA module 120 fails to receive.

In operation S350, the gateway 200 extracts all of the sequence numbers of the OTA packets that the LPWA module(s) fail to receive from the OTA response messages, and the gateway 200 retransmits to a respective LPWA module 120 the failed OTA packet corresponding to the sequence number that the respective LPWA module 120 fails to receive. Alternatively, the gateway 200 may also retransmit all packets of the first subgroup.

Further, the gateway 200 may transmit the OTA request message including the sequence number of the first subgroup to the plurality of LPWA modules in operation S340. Accordingly, the LPWA modules 120 may recognize that the packet included in the first subgroup will be retransmitted by receiving the OTA request message including the sequence number of the first subgroup. Further, the LPWA modules 120 may each transmit the positive acknowledgement (ACK) to the gateway in operation S345.

As described above, since the gateway 200 transmits the OTA packets in the unit of a subgroup, an efficient re-transmission of the OTA packets may be performed in the unit of a subgroup when the LPWA modules 120 fail to receive the OTA packets.

Further, since each of the LPWA modules 120 receives the sequence number of the failed OTA packet and the failed OTA packet required by each of the LPWA modules 120 is retransmitted in response to the reception failure, completion of the firmware updating may be secured.

Next, in a case in which the OTA response message received by the gateway 200 from an LPWA module 120 indicates the reception completion for the packet of the first subgroup, the gateway 200 performs a procedure for transmitting the remaining subgroups in operation S370. For example, the gateway 200 transmits the OTA request message including the OTA transmission time to the LPWA modules 120, and may receive an OTA response from each of the LPWA modules 120 after sequentially transmitting OTA packets of a second subgroup.

The OTA packet transmission procedure may proceed until the gateway 200 receives the OTA response message that indicates the reception completion of the final subgroup in operation S380). Further, the reception completion of the final subgroup indicates the reception completion of the firmware source, and the gateway 200 transmits an update instruction message to the LPWA modules 120 in operation S390 The update instruction may be included in the OTA request message so as to be transmitted as the OTA request message.

The method for updating the firmware of the LPWA modules 120 described above may be applied to a case in which a multicast communications method is supported between the gateway 200 and the LPWA modules 120. For example, the LPWA modules 120 wait in a state in which the LPWA modules open a receive window, which is a buffer space for receiving data, and closes the receive window only during uplink transmission. That is, since the LPWA modules 120 wait for the downlink of the gateway 200, the gateway 200 may transmit the data in an OTA multicast communications method with the LPWA modules 120.

The OTA unicast and OTA multicast communications methods may have a trade-off relationship between latency and power consumption.

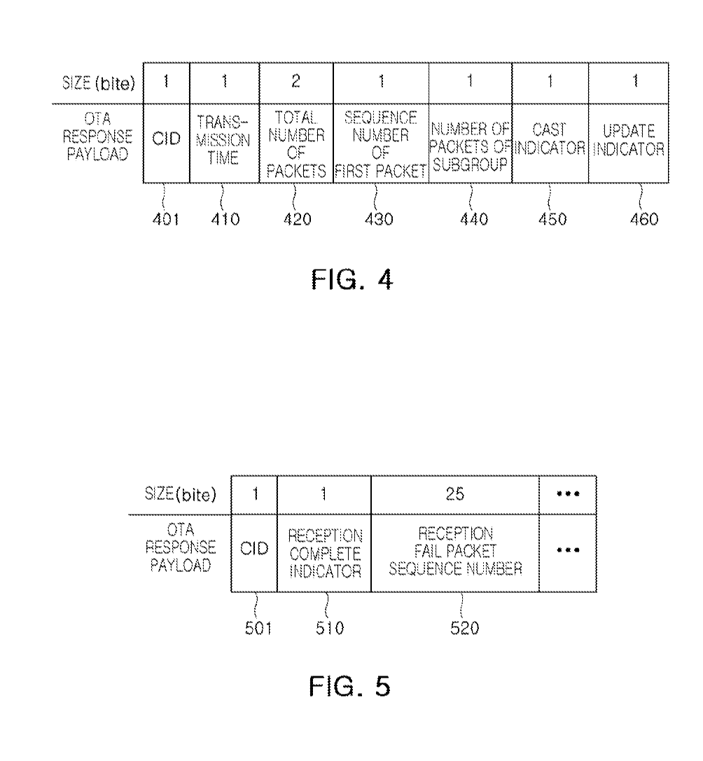

FIG. 4 is a diagram illustrating a frame structure of an OTA request message, according to an embodiment. FIG. 5 is a diagram illustrating a frame structure of an OTA response message, according to an embodiment. In FIGS. 4 and 5, only a structure of a payload except for a header is illustrated.

The frame structure of FIGS. 4 and 5 uses a message format of an MAC protocol. Therefore, the frame structure may be easy to implement and compatibility may be ensured.

Further, the OTA request message is transmitted to the LPWA module 120 (FIG. 1) through the gateway 200 (FIG. 1) from the server 300 (FIG. 1), and the OTA response message is transmitted to the server 300 through the gateway 200 from the LPWA module 120.

Referring to FIG. 4, the OTA request message includes caller identification (CID) 401 having a size of 1 byte. Further, the OTA response message includes a transmission time 410, a total number of packets 420, a sequence number 430 of a first packet, a number of packets of the subgroup 440, a cast indicator 450, and an update indicator 460.

The transmission time 410 may indicate a time at which the transmission of the OTA packet starts after the transmission of the OTA request message. The LPWA module 120 may open the receive window at the transmission time. The total number of packets 420 indicates the total number of packets transmitted to update firmware. The sequence number 430 of the first packet may indicate a sequence number of a packet which is transmitted first during the transmission of the OTA packet after the transmission of the OTA request message. The number of packets of the subgroup 440 indicates the number of packets included in a subgroup when the OTA packet is transmitted in a unit of subgroup. The cast indicator 450 indicates whether the transmission of the OTA packet is performed by the unicast communications method or the multicast communications method. The update indicator 460 indicates whether the gateway instructs the firmware update of the LPWA module 120.

Referring to FIG. 5, the OTA response message includes caller identification (CID) 501 having a size of 1 byte. Further, the OTA response message includes a reception complete indicator 510 and a reception fail packet sequence number 520.

The reception complete indicator 510 indicates whether the reception of the OTA packet is completed according to the reception of the OTA request message. The reception fail packet sequence number 520 indicates the sequence number of the failed OTA packet that the LPWA module 120 fails to receive.

As set forth above, according to the embodiments disclosed herein, a method for updating firmware of an LPWA module provides an efficient OTA protocol between a gateway and the LPWA module to update the firmware of the LPWA module.

Further, the efficient OTA protocol may use a multicast scheme for multiple LPWA modules to update the firmware of the LPWA modules.

The LPWA apparatus 100, the application apparatus 110, the LPWA module 120, the gateway 200, and the server 300 in FIG. 1 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2 and 3 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method to update firmware of a low power wide area (LPWA) module, the method comprising:
transmitting, from a gateway, an over the air (OTA) request message comprising an OTA transmission time to the LPWA module;
transmitting, from the gateway, OTA packets comprising a firmware source to the LPWA module at the OTA transmission time; and
receiving, at the gateway, an OTA response message from the LPWA module confirming whether a reception of the plurality of OTA packets is completed.

2. The method of claim 1, wherein the transmitting of the OTA request message is performed after the gateway receives an uplink of the LPWA module.

3. The method of claim 1, wherein the transmitting of the OTA packets comprises
transmitting an OTA packet, among the OTA packets, to the LPWA module, and
transmitting a next OTA packet, among the OTA packets, to the LPWA module in response to receiving a positive acknowledgement (ACK) from the LPWA module.

4. The method of claim 1, wherein the OTA response message comprises a sequence number of a failed OTA packet, among the OTA packets, that fails to be received by the LPWA module.

5. The method of claim 4, further comprising retransmitting the failed OTA packet in response to the gateway receiving the OTA response message comprising the sequence number of the failed OTA packet.

6. The method of claim 1, further comprising transmitting an update instruction message to the LPWA module in response to the OTA response message indicating a reception completion of the firmware source.

7. The method of claim 1, wherein the OTA request message comprises an indicator indicating a unicast or multicast communications method.

8. A non-transitory computer-readable storage medium storing instructions that, when executed by a processor, cause the processor to perform the method of claim 1.

9. A method to update firmware of low power wide area (LPWA) modules, the method comprising:
transmitting, from a gateway, an over the air (OTA) request message comprising an OTA transmission time to the LPWA modules;
transmitting, from the gateway, OTA packets comprising a firmware source to the LPWA modules as a subgroup at the OTA transmission time; and
receiving, at the gateway, an OTA response message from each of the LPWA modules confirming whether a reception of the subgroup is completed.

10. The method of claim 9, wherein the transmitting of the OTA request message is performed after the gateway receives an uplink of a respective LPWA module, among the LPWA modules.

11. The method of claim 9, wherein the OTA request message further comprises a sequence number of the subgroup, and a quantity of the OTA packets included in the subgroup.

12. The method of claim 11, wherein the sequence number of the subgroup comprises a sequence number of a first OTA packet, among the OTA packets, included in the subgroup.

13. The method of claim 9, wherein the OTA response message comprises a sequence number of a failed OTA packet, among the OTA packets, that fails to be received by a respective LPWA module, among the LPWA modules.

14. The method of claim 13, further comprising retransmitting the failed OTA packet in response to the gateway receiving the OTA response message comprising the sequence number of the failed OTA packet.

15. The method of claim 9, further comprising transmitting an update instruction message to a respective LPWA module, among the LPWA modules, in response to the OTA response message indicating a reception completion of the firmware source.

16. The method of claim 9, wherein the OTA request message comprises an indicator indicating a unicast or multicast communications method.

17. A non-transitory computer-readable storage medium storing instructions that, when executed by a processor, cause the processor to perform the method of claim 9.
